(19) United States
(12) Patent Application Publication
(10) Pub. No.: US 2011/0296429 A1
(43) Pub. Date: Dec. 1, 2011

(54) SYSTEM AND METHOD FOR MANAGEMENT OF LICENSE ENTITLEMENTS IN A VIRTUALIZED ENVIRONMENT

(75) Inventors: WOLFGANG SEGMULLER, Valhalla, NY (US); Malgorzata Steinder, Fort Lee, NJ (US); Ian N. Whalley, Pawling, NY (US)

(73) Assignee: INTERNATIONAL BUSINESS MACHINES CORPORATION, Armonk, NY (US)

(21) Appl. No.: 12/791,353

(22) Filed: Jun. 1, 2010

(51) Int. Cl. G06F 9/50

(52) U.S. Cl. 718/104

(57) ABSTRACT

A management system and method for a virtualized environment includes a computer entity having a usage limitation based on an entitlement. A resource manager, using a processor and programmed on and executed from a memory storage device, is configured to manage resources in a virtualized environment. An entitlement-usage module is coupled to the resource manager and is configured to track entitlement-related constraints in accordance with changes in the virtualized environment to permit the resource manager to make allocation decisions which include the entitlement-related constraints to ensure that the usage limitation is met for the computer entity.

### BACKGROUND

1. Technical Field

The present invention relates to virtualized system management and more particularly to a system and method configured to account for usage rights and limitations in managing a virtualized environment.

2. Description of the Related Art

Modern enterprise software carries significant purchase costs, complex licensing terms, and serious penalties to the customer in the event of a licensing violation. Traditionally, software was licensed simply in terms of installed copies, i.e., the customer paid a certain amount for each copy of the software that was installed. The cost of the software for the customer was therefore the number of copies that the customer was using (or, more accurately, had installed) multiplied by the price that the customer paid per copy. Another technique that has been used is the so-called “license pool”. In this technique, the customer only pays for the copies of the software that are currently running—as many copies as necessary can be installed, but only so many of them can execute concurrently. Both of these models have been, and still are, widely used in the field of workstation software—software that runs on individual personal computers.

Modern server software has even more complex licensing terms. As a driving example, consider the “Processor Value Unit” methodology or PVU. This approach does not simply license software by installed instance, but based on an attempt to measure a potential value that the customer receives from the software.

PVU-based product licensing does not charge a flat rate for the product. Instead, products are priced in terms of PVUs. When purchasing a PVU-licensed product, the customer works out how many PVUs are needed, and multiples that number by the per-PVU price of the product in question.

By way of example, a list price of an application server is $60 per PVU. To complete the pricing calculation, the customer next looks at the CPUs upon which he intends to run the product. Each processor type has a defined “PVUs per core” value, which tells the customer how many PVUs to buy. For example, in the present example, a table lists the price of PVUs-per-core value for all processors (with multiple cores) as 50. Therefore, a customer wishing to run the application server on a machine with eight cores needs to have 8*50=400 PVUs of the application server. If cost per PVU were $60, this would cost 60*400==$24,000.

One important aspect of PVU-based licensing is that it does not matter how many copies of the application server that the customer installs and runs, only how many PVUs those copies have access to. For example, the customer could decide instead to run two machines each of which has four cores, and the PVU requirement would remain 400 (2*4*50). In addition, the customer could decide to run seven copies of the application server on each of those two machines, and his PVU requirement would continue to be 400.

In this scheme, PVUs are not interchangeable between products. They are interchangeable across CPU types and machines. By way of example, the customer who has purchased 400 PVUs for the application server can run the application server on whatever machines the customer wishes, provided that the customer does not run on CPUs that need more than a total of 400 PVUs. However, the customer cannot stop running the application server and run another (second) software product that is licensed using the PVU scheme instead. The per-PVU price for the second software product is different from that for the application server, and so the customer cannot use PVUs purchased for one product to run another product.

Consequently, it can be seen that in any given system, there will be a variety of licensed products deployed, and the customer needs to track its entitlements and usage for each product to ensure compliance with the terms of the license.

### SUMMARY

A management system and method for a virtualized environment includes a computer entity having a usage limitation based on an entitlement. A resource manager, using a processor and programmed on and executed from a memory storage device, is configured to manage resources in a virtualized environment. An entitlement-usage module is coupled to the resource manager and is configured to track entitlement-related constraints in accordance with changes in the virtualized environment to permit the resource manager to make allocation decisions which include the entitlement-related constraints to ensure that the usage limitation is met for the computer entity.

A method for managing resources in a virtualized environment includes representing constraints for a set of entitlements and determining, for a computing entity to be placed, how many and what type of entitlements are permitted. Entitlement usage is computed for a current candidate placement solution as a placement program progresses, such that a resulting placement solution does not exceed the entitlements that are available.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram of a system/method which considers licensing/entitlements in managing a virtualized environment;

FIG. 2 is a block diagram showing an illustrative example for a placement management system in accordance with the present principles;

FIG. 3 is a block diagram showing an illustrative example for managing an environment while considering licensing/entitlements;

FIG. 4 is a block diagram showing another illustrative example for managing the environment of FIG. 3 while considering licensing/entitlements with an added VM;

FIG. 5 is a block diagram showing another illustrative example for managing the environment of FIG. 4 while considering licensing/entitlements with PVU sharing;

FIG. 6 is a block diagram showing another illustrative example for managing the environment of FIG. 3 while considering a placement position of an added VM;

FIG. 7 is a block diagram showing another illustrative example for managing the environment of FIG. 4 while considering a placement position of an added VM with PVU sharing;

FIG. 8 is a block diagram of a model construct showing relationships between computer entities and bundles of entitlements in accordance with one embodiment;

FIG. 9 is a block/flow diagram showing a placement method considering licensing/entitlements in accordance with one illustrative embodiment; and

FIG. 10 is a block/flow diagram showing another placement method considering licensing/entitlements in accordance with another illustrative embodiment.

### DETAILED DESCRIPTION OF PREFERRED EMBODIMENTS

In accordance with the present principles, a system and method for integrated management of a virtualized environment are provided. In particularly useful embodiments, a management system includes license awareness and employs this awareness into its decisions and actions. For example, when the management system is capable of deploying new virtual machines, and of migrating existing virtual machines from place to place, the benefits of including license awareness are even more significant.

Virtualization is a general term that refers to the ability to make computing resources abstract. The present embodiments may be included in platform virtualization, which includes the virtualization of computer systems (as opposed to storage or networks, for example, although these may be employed as well). One type of virtualization is full virtualization, wherein multiple, usually isolated, operating system instances can be run on a single computer. Other types of virtualization are also included, e.g., operating system-level virtualization, wherein within a single operating system, multiple usually isolated, spaces are presented, inside which programs run.

Examples of full virtualization include IBM®'s DLPARs (on pSeries and zSeries), IBM®'s z/VM, VMware®'s family of products, Citrix®'s XenServer and Xen, and Linux™'s KVM to name a few. Common examples of “operating system-level virtualization” include IBM®'s WPARs for the AIX operating system, Sun®'s Solaris Containers, and Linux™'s VServers.

Virtual machines may, e.g., refer to either operating system instances (in the case of full virtualization) or spaces (in the case of operating system-level virtualization). One of the relevant aspects of virtualization is the ability to control CPU allocations. For example, when running multiple virtual machines on a single physical machine, it is possible to limit which, and how many, CPUs in the physical machine (or physical CPUs) each virtual machine has access to.

For example, consider a single physical machine with eight processor cores. The physical machine can run three virtual machines, the first of which has two virtual CPUs, the second of which has four virtual CPUs, and the third of which has eight virtual CPUs. Software running inside the virtual machines can only equal the number of CPUs to which the virtual machine has access.

Another aspect includes live migration (also referred to as partition mobility and migration). This refers to the ability to move a virtual machine from one physical machine to another without interrupting service.

An intersection between virtualization and software licensing may combine PVU-type licensing and virtualization. Combining the virtual machine example from above and the earlier the Application Server example, the customer should be permitted to run the Application Server in all three virtual machines for the original 400 PVU requirement. All 8 physical cores are being used, so all 8 must be licensed. Running multiple copies of the Application Server on a single machine did not change the licensing requirement, the fact that the different instances are running in separate virtual machines is not relevant in this licensing scheme. In other words, the most PVUs that the customer needs to purchase to run the Application Server on this machine is 400—it does not matter how many instances or virtual machines are in play.

Consider sharing of PVUs. In this instance, the eight virtual CPU, virtual machines are created first. Later, the four virtual CPU and the two virtual CPU virtual machines are created. No additional licenses are needed for the second two VMs, they are “sharing” the licenses that were needed to create the first virtual machine. There is nothing special about that first virtual machine, however—in this example, it was merely the one that was created first, and so it precipitated the need to license the physical cores. No additional licenses are needed to deploy the next two virtual machines.

If a customer needs fewer than 400 PVUs, such as, e.g., when the customer only runs the Application Server in the first virtual machine (the one that has two virtual CPUs). In this case, the customer only needs 100 PVUs (50 for each of the two physical cores). In this type of licensing on this platform, the customer needs to have sufficient PVUs for the lower of the sum of virtual CPUs or the number of physical cores. It should be understood that the above description of PVU-type licensing is not intended to be limiting as details have been omitted for clarity, and issues of clustering and other platform types have been entirely left out. The above description is intended to be merely illustrative of an environment in which the present principles can be implemented. In addition, other software providers have other licensing schemes. However, several of them have aspects that are similar to the PVU-based scheme described above.

As virtualization becomes more and more prevalent in end-user data centers, virtualization management becomes more important. There have been significant advances in the field of performance management, high-availability, and even electrical power conservation. However, one neglected area that provides significant benefits to the customer is license management. In particular, the ability to consider license management along with other management concerns is particularly useful. Both deployment and migration can change the number of licenses used by the system at any given time. For example, consider again the three virtual machine case used above, but introduce a second physical machine that initially has no virtual machines deployed upon it. It can be understood that migrating a virtual machine from the first physical machine to the second will increase the number of PVUs needed to license the whole system—there are now more physical cores running the Application Server than there were before. Numerous other cases involving deployment and migration could also be cited.

In accordance with the present principles, an integrated management system includes license awareness features. When the management system is capable of deploying new virtual machines, and/or of migrating existing virtual machines from place to place, license awareness is considered in making decisions or performing such actions. The system considers license requirements in addition to other management considerations.

Throughout this disclosure, reference will be made to a single customer; however, the present embodiments are equally applicable to a set of customers with separate licenses sharing an infrastructure. Some the features provided by the present embodiments include the following. Obtaining, by one or more mechanisms, such as eliciting information from a system administrator, or electronically contacting software suppliers to ask for the information, license entitlements, and corresponding license types, for the current customer's software products. These license entitlements and license rules are taken into account, for gathering sufficient information about the infrastructure being managed so as to be able to compute the current license usage. This information includes, but is not limited to: The number and characteristics of the various physical machines in the system. The number and characteristics of the virtual machines currently deployed (if applicable). Information about which software product is installed and where it is installed.

When considering a potential change to the system under management, the present embodiments are able to calculate the effects (in terms of licenses needed) of that change to that system, and evaluating different sets of potential changes in terms of their impact on the license requirements, in addition to other system-level impacts (including, e.g., performance, availability, power consumption, etc.). The present embodiments are capable of selecting a set of changes to make to the system that keep the system within the customer's license entitlements. In the event that this is not possible, various approaches to override the system are possible. In one embodiment, the system cannot override license entitlements. In another embodiment, the system can do so, but only with the permission of a system administrator. Other embodiments are also possible.

In one example, a data center includes one hundred physical machines. License usage can be minimized by placing all licensed products on the same physical machines, and not using any of the others (such an approach would also have a beneficial effect on power consumption). However, the performance of the system would likely suffer, as the single physical machine has insufficient resources to adequately host all licensed products. Such a solution also has a negative impact on availability—when that single machine fails, everything will fail.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

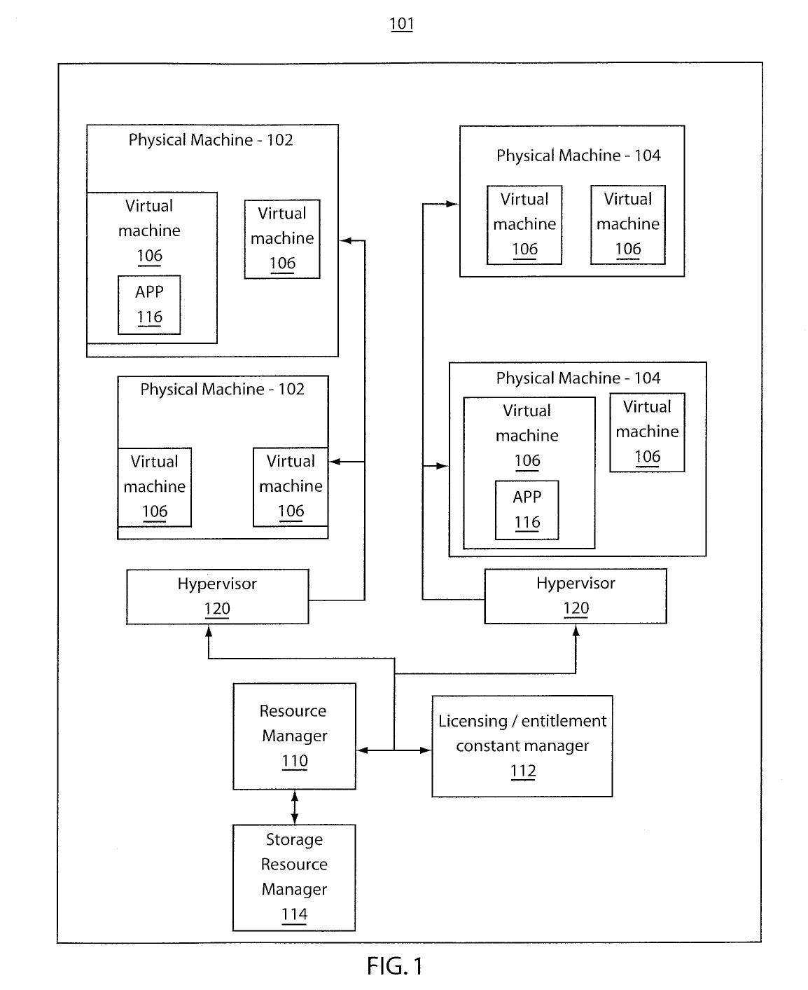

Referring now to the drawings in which like numerals represent the same or similar elements and initially to FIG. 1, a system 101 is illustratively depicted which takes usage rights, limits and constraints into account to provide for integrated management in a virtualized environment. System 101 illustratively includes a virtual environment having physical machines 102, 104, virtual machines (VM) 106, a resource manager 110, a licensing/entitlement constraint management module 112 and a storage resource manager 114. System 101 may include a data center environment, a network environment or any other computer environment where computer artifacts or entities are provisioned, changed, executed, migrated, etc. Computer artifacts or entities may include virtual machines (VMs). Virtual machines are illustratively employed for the present illustrative system description. It should be understood that the applications or another other computational entities may be employed in a similar manner.

Applications 116 are hosted by individual VMs 106, and physical machines 102, 104 may host multiple VMs 106. Each VM 106 has a share of resources (network, memory and CPU) allocated at boot time to the VM 106 and shares resources with other VMs 106 co-hosted in the same physical machine 102, 104. The physical machines may host multiple VMs 106. VMs 106 can be migrated to other physical machines or environments.

Storage resource manager 114 is responsible for monitoring storage usage across the storage in the system 100. The resource manager 110 is responsible for making decisions regarding the placement or repositioning (migration) and reprovisioning of virtual machines 106, and coordinates with the module 112 and storage resource manager 114, when needed, e.g., when a VM 106 has been selected for potential repositioning. Placement refers to a decision as to where a given virtual machine should run at a given time.

Placement decisions may be made based upon a plurality of different considerations. For example, performance-aware placement of virtual machines considers performance gains as a result of VM placement, while constraint-aware placement of virtual machines is based on constraints. Constraint-aware decisions may consider allocation restrictions (e.g., “don't place this at a particular location”, “this can only go to location x, y, and z”) and collocation restrictions (“this cannot cohabit with that”, “this cannot cohabit with anything”, etc.). Licence-aware placement may be included in both performance-aware and/or constraint-aware placement. Initial deployment of virtual machines may consider additional contributions at deployment time. For example, network connections, storage availability, etc.

Resource manager 110 and hypervisors 120 are employed in managing VM storage, migration, application execution and other management functions. The licensing constraint management module 112 may be integrated with/into one or both of the resource manager 110 and hypervisor 120. During a migration, system 101 performs the following illustrative functions: (1) resource manager 110 designates a VM 106 for migration or reprovisioning. (2) resource manager 110 consults the licensing constraint management module 112 to determine whether constraints exists on moving the VM 106 from its current location and to a new location. This includes determining whether constraints exist to prevent movement to the new location or from the old location. The licensing constraint management module 112 stores constraint information which may be from service level agreements (SLAs), licensing agreements, copyright information, etc. In accordance with useful embodiments, the licensing constraint management module 112 is consulted by the resource manager 110 as part of the decision making process for any changes in resources. The licensing constraint management module 112 can provide a caller with a current level of usage of each entitlement type.

The resource manager 110 provides a management system that includes license awareness in its decisions. When the management system deploys new virtual machines (106), migrates existing virtual machines (106) from place to place, executes applications or VMs and/or reprovisions VMs (106) license awareness becomes significant, the management system considers licenses (and other usage constraints) in addition to other management considerations. The licensing constraint management module 112 of system 101 further includes the ability to prioritize competing constraints.

The licensing constraint management module 112 obtains entitlement data, using various mechanisms including: eliciting the information from a system administrator, electronically contacting software suppliers to ask for the information, considering license entitlements, corresponding license types, etc. for a current customer's software products. The resource manager 110 (and or the licensing constraint management module 112) accounts for the license entitlements and license rules and gathers sufficient information about the infrastructure being managed so as to be able to compute the current license usage. The information includes, but is not limited to, e.g., number and characteristics of the physical machines 102, 104 in the system 101; the number and characteristics of the virtual machines 106 currently deployed (if applicable); information about which software products are installed and their location; etc.

When considering a potential change to the system under management, the effects of such change need to be computed (in terms of licenses needed, etc.) for that change to that system. Different sets of potential changes may be evaluated in terms of their impact on the licenses requirement, in addition to other system-level impacts (including, e.g., performance, availability, power consumption, etc.). A set of changes or is selected that can ensure that the system is kept within the customer's license entitlements. In the event that this is not possible, various approaches to override the system are possible, or a best solution that follows the spirit of the license agreements can be selected. In one embodiment, the system cannot override license entitlements. In another, the system can do so, but only with the permission of a system administrator. Other embodiments are also possible.

Product licence rules for virtualized environments are often complex. More recently, products may be charged based on how much work they can do, not based on the number of installed copies. As a result, licence usage depends on how installed copies of a product are placed on physical hardware. Processor Value Units (PVUs) are employed as an illustrative example to address virtualized environments. A PVU score determines the licence cost of a particular processor type. Each processor used by a product must be paid for. A processor used by multiple copies of the same product needs to be paid for only once. A processor is used by a product when the product is installed in a VM that can use that processor, and stopped products and stopped VMs count as usage. Each processor used by a product in each 24 hour period that starts at midnight GMT is counted, VM migration impacts PVU usage, special clustering rules for VMware prevents overcharging when Distributed Resource Scheduling (DRS) is in use (but only then).

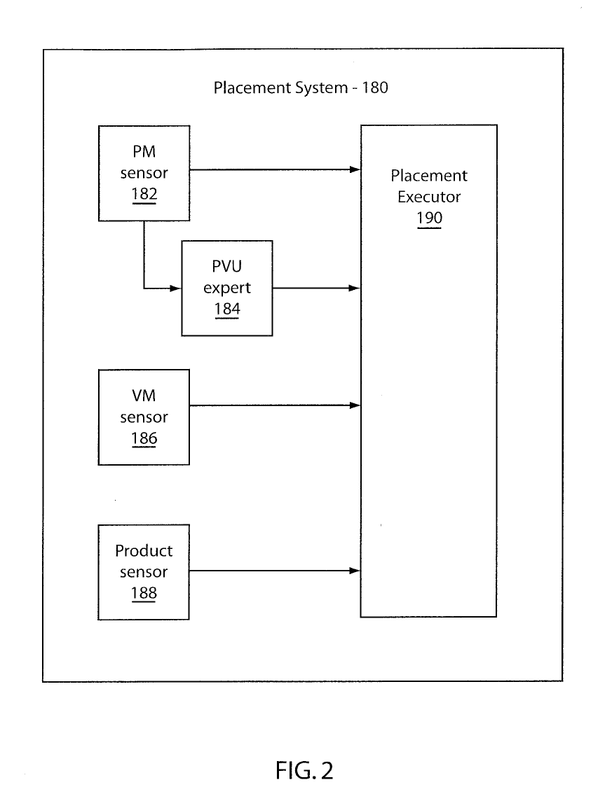

Referring to FIG. 2, a placement system 180 is included in the constraint manager 112 of FIG. 1. To determine entitlement usages, it is necessary for the placement system 180 to be able to compute, for all possible placements, a current usage of all entitlements. In addition, the placement system 180 needs to be able to compute the effect on those entitlement usages for making a particular change to the placement. Taking as an example the license entitlements described herein, and more specifically (for the purposes of explanation only) the PVU licenses, the placement system 180 needs to know the following information: a number of physical cores on each physical machine (104); a PVU ‘score’ of each of those physical cores; a number of virtual cores that each product in each virtual machine has access to; and the product(s) in each virtual machine.

Given this information, the placement system 180 can compute, at any time, the number of entitlements that a given placement of virtual machines consumes. It can be seen, therefore, that as a placement routine progresses, it can recompute the amount of each entitlement that has been used at every step. Further, when the placement routine considers making a change, it can compute the effect that that change would have on each and every entitlement in the system.

To implement system 180, sensors are implemented to determine the information needed. A physical machine (PM) sensor 182 detects the properties of the physical machines (104), which is then coupled with a software component (for example, a database) or a PVU expert 184 that knows the PVU ‘scores’ for given processor types and quantities. A virtual machine (VM) sensor 186 provides information about virtual machines, and a product sensor 188 provides information about installed products and their license terms. The placement system 180 may include modified PM sensors 182 and VM sensors 188 that have been extended to support gathering this and other needed data.

The placement system 180 conveys the system data (from the sensors) into a canonical form in a placement executor 190, separating the concerns of the placement system from the specific implementations of the sensors. The placement executor 190 will then examine that canonical form while making its decisions about what changes to make. This canonical form will include the Buckets of Entitlement (BoEs), etc. as described herein.

In addition, implementations of the system 180 include on-going optimization and management of the system over time. Events from the sensors (182, 186, 188) will trigger the placement system 180 to reevaluate the current placement. These events will include changes to entitlement requirements or entitlement availability.

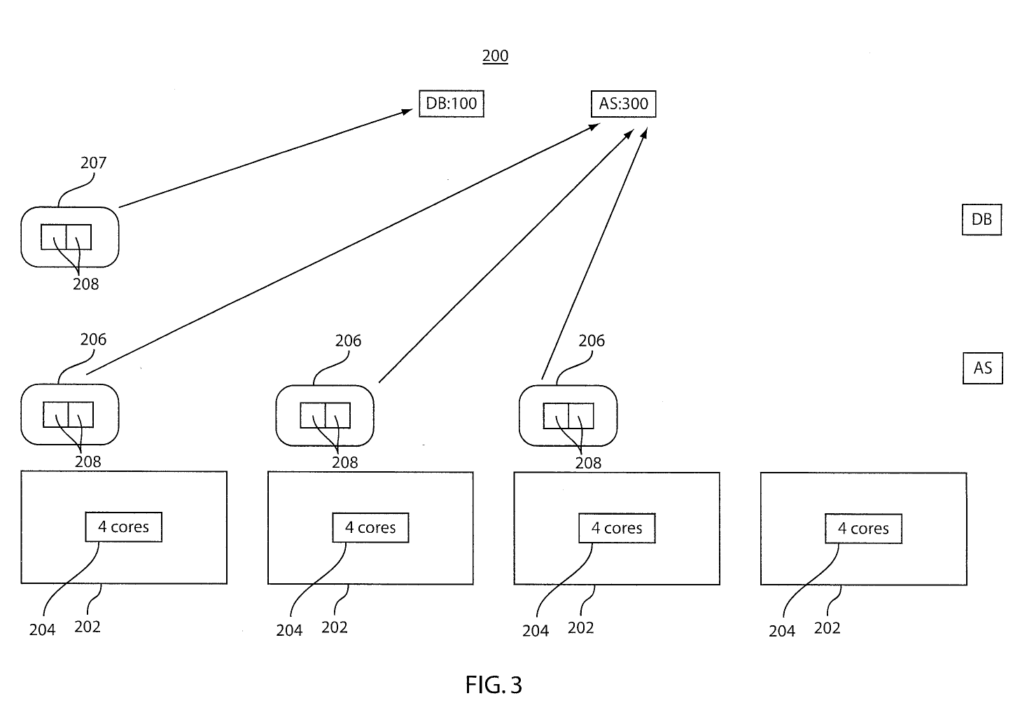

Referring to FIG. 3, a simplified PVU system 200 is depicted for demonstrating concepts in accordance with the present principles. Four physical machines (PMs) 202, each include four physical computer processing units (pCPUs) 204. Each pCPU 204 includes, e.g., 50 PVUs. All VMs 206 and 207 include two vCPUs 208. In FIG. 2, three VMs 206 run an application server (AS) application, e.g., IBM®'s Websphere Application Server™, and one VM 207 runs a database (DB) application (e.g., IBM®'s DB2™). The PVU usage of the application server application (AS) is 300 since each VM 206 uses two pCPUs 204 (2×50=100 each). The PVU usage of the database application (DB) is 100 since each VM 207 uses two pCPUs 204 (2×50=100 each).

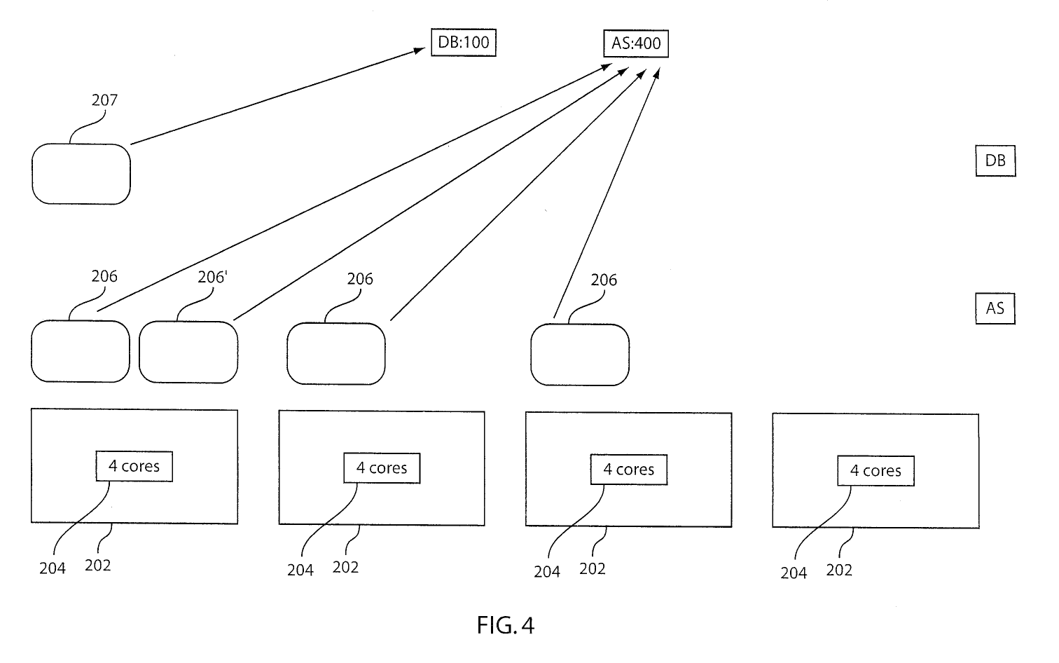

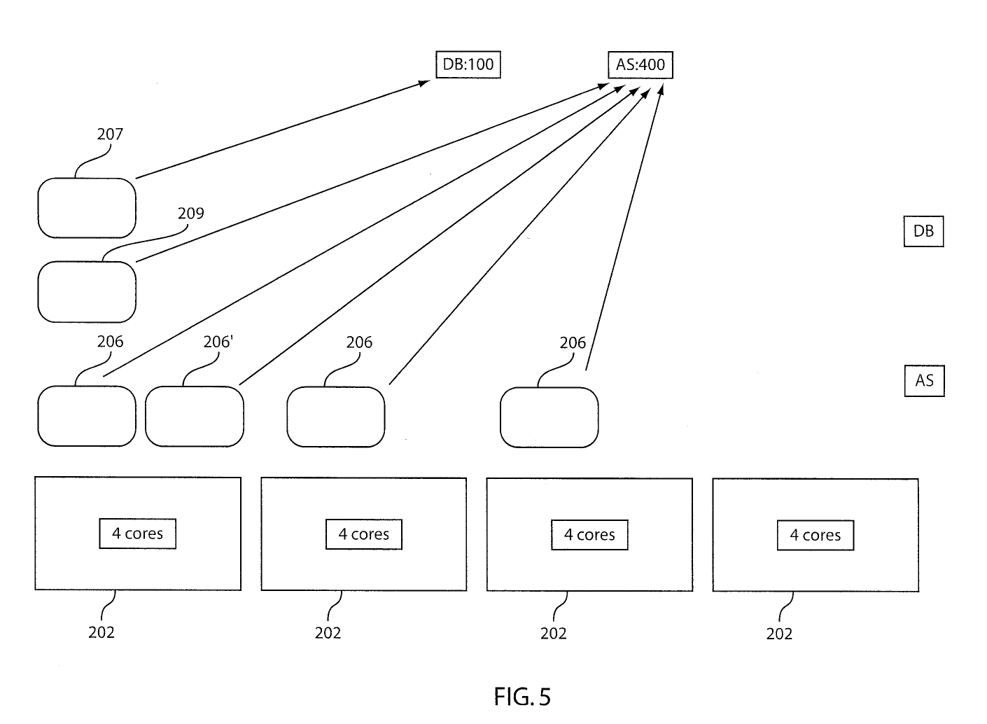

In FIG. 4, a fourth VM 206′ runs the application server application and increases the PVU consumption for this application from 300 to 400. In FIG. 5, a new VM 209 is created and benefits from sharing the same machine and CPUs. No additional PVU consumption is experienced by including VM 209 on a processor that already is counted in the PVU count.

Referring again to FIG. 3, let us say that a customer has purchased 400 PVUs of the AS application. During an enforcement mode of the system 101 at setup time (or other time), license module 112 or resource manager 110 (FIG. 1) checks compliance. While 400 PVUs are being proposed for usage, in this scenario 100 are being used for DB and assume that the customer is not authorized to use the DB application. In this case, a violation exists. The system 101 (FIG. 1) can contact the customer and sign him up for 100 PVUs of the DB application or simply send out a warning that the application is not available under current licensing arrangements. In one embodiment, the enforcement mode would shut down the unauthorized usage of the DB application to ensure that entitlements are complied with.

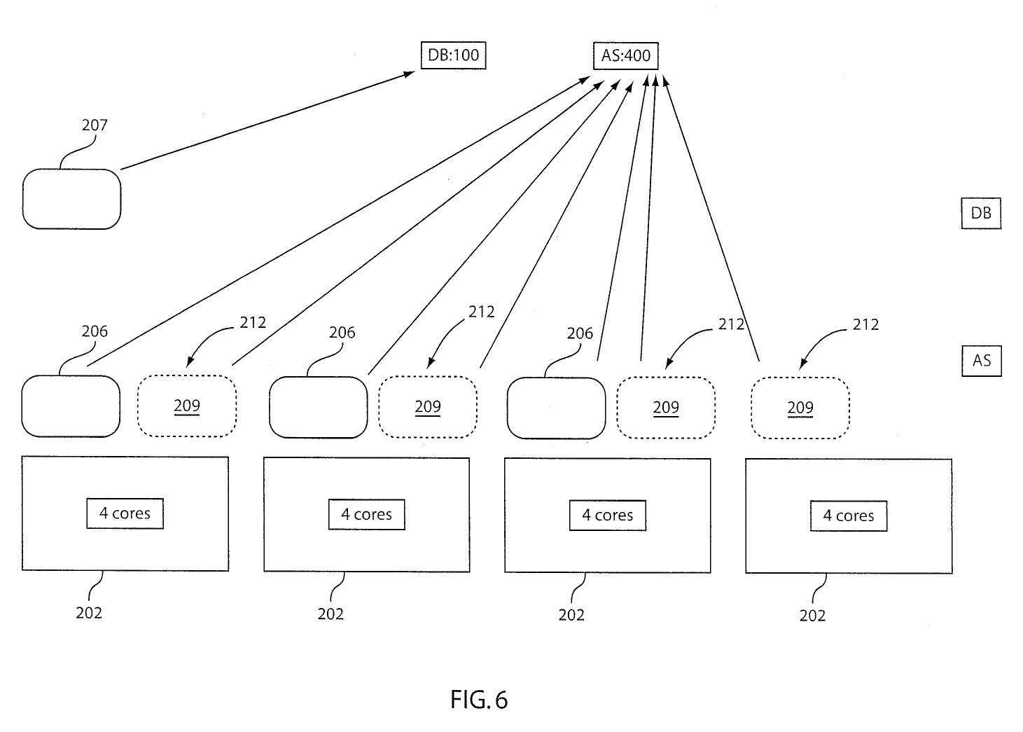

In FIG. 6, the arrangement of FIG. 3 permits the addition of a new VM 209 (as in FIG. 5); however, a choice exists in the placement of VM 209. Four positions 212 exist for VM 209. All positions will result in an AS PVU consumption of 400 and all placements are valid. However, the placement of VM 209 is each position 212 is not equivalent in each case. The management decision may include additional criteria, such as performance-based placement to determine a best position of the VM 209.

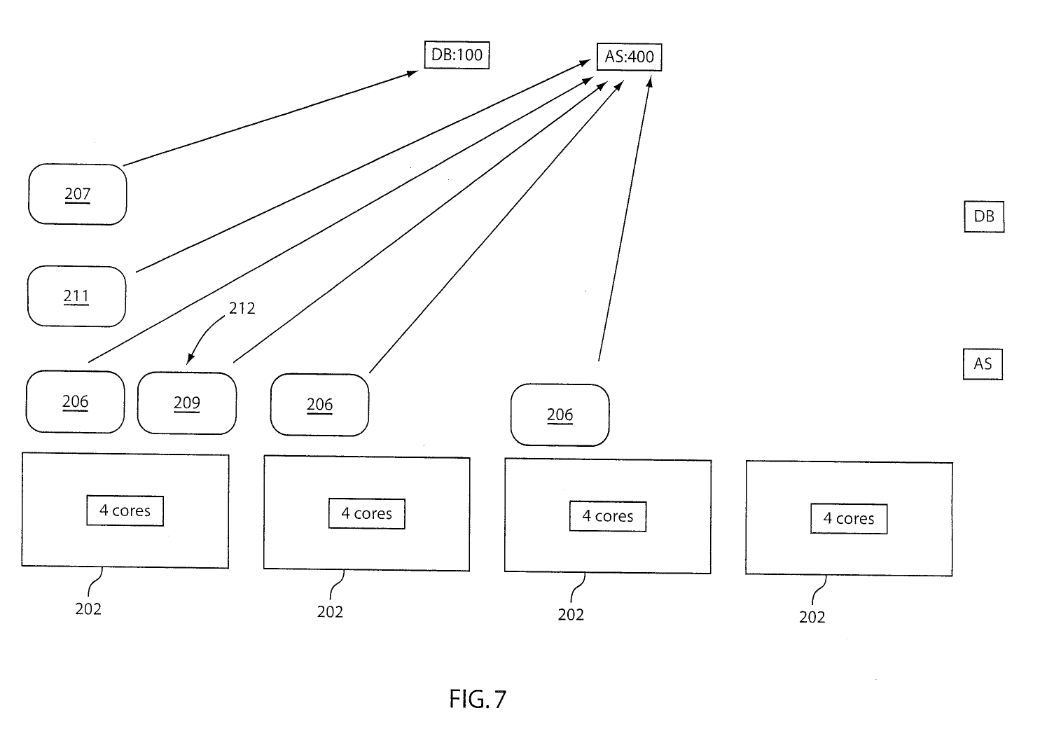

In one example, if another VM (not shown) needs to be placed for AS use in addition to VM 209, it cannot be—since the PVU limit 400 would be exceeded. The new VM cannot be placed since all options will violate the AS PVU limit. The customer could sign up for more PVUs for the AS application or other actions could be taken. Another scenario can solve this problem. As depicted in FIG. 7, the first new VM 209 is placed on a first PM 202 (left-most PM) in one of the four positions 212, and a new VM 211 can be placed to trigger PVU sharing (see FIG. 5). In this way, PVU for AS is maintained under the 400 PVU limit, and the extra VM 211 is accommodated.

In another example, only one PM 202 is available for PVU sharing. A migration of VMs may be employed to ensure PVU compliance and balance performance. For example, PMs 202 may be fully populated to share resources and avoid PVU consumption.

Moving VMs may cause a problem with the 24 hour rule. If any PM 202 is in-use within a 24 hour period the PVUs must be paid for. For example, two AS VMs exist. One VM runs at midnight and is destroyed at 6 AM, a second VM is created at noon and destroyed at 6 PM. The PVU consumption for this scenario is 200, even though only 100 PVUs were in use at any time. The 24 hour rule exists to avoid license compression. So migrating a VM may include additional costs. This can be addressed using special PVU counting rules. These rules may be input as constraints and employed in accordance with the present principles to ensure entitlement compliance and to optimize usage.

In another example, as above, usage for a given day is 200 PVUs under the 24 hour rule. If no new VMs are placed, the next day's usage will be zero if the VMs are decommissioned. However, IBM® License Metric Tool (ILMT), which helps clients determine their full and virtualization capacity (sub-capacity) PVU licensing requirements (or other PVU metric tools) do not know that the VMs have been decommissioned. These tools will continue counting for four weeks, for example, assuming that nothing has changed. This also can be addressed using license-aware placement in accordance with the present principles.

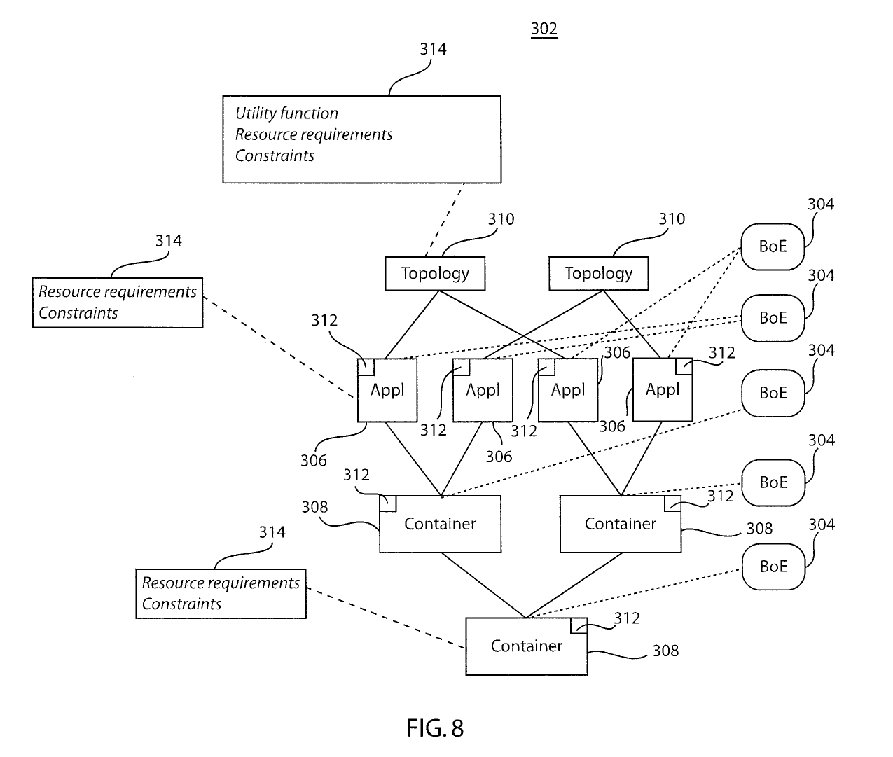

Referring to FIG. 8, a modelling construct 302 may be employed by module 112 (and system 180) to provide license-aware placement of applications, virtual machines, computer entities or the like. VM placement affects software license usage. Software licence fees depend on the type and capacity of machines where software is installed and on resource availability to a software instance. Dynamic placement may lead to the violation of software license rules. In accordance with one illustrative embodiment, the construct 302 defines relationships through connections and captures software license limits of a software component. Each VM/application 306 and container 308 is associated with one or more Buckets of Entitlement (BoEs) 304. The BoEs 304 include license capacity and license usage calculation rules and may be used to model other kinds of restrictions as well. Types of license limits may be full capacity based, sub-capacity based, based on a number of instances, based on a number of physical machines, etc.

One or more topologies 310 are included in an environment monitored by the license-aware placement. Topologies 310 provide a structure for VMs/applications 306 and containers 308. Topologies 310, VMs/applications 306 and containers 308 may all have resource requirements handled by a resource manager (110, FIG. 1) and include constraints which may be related to performance, system administration, licenses, etc.

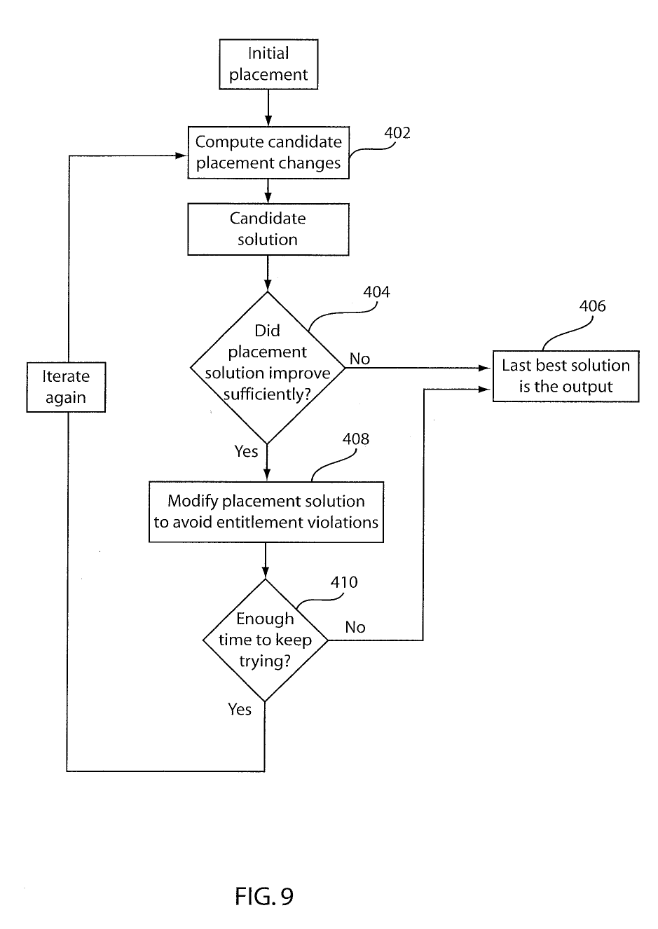

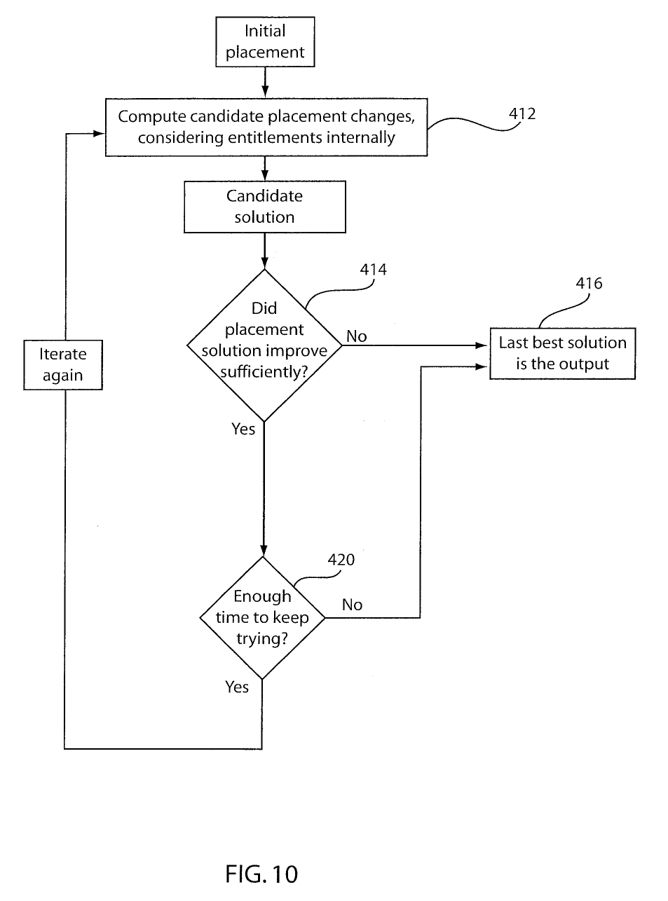

BoEs 304 are defined at topology creation time and are provided to a placement system at deployment time. BoEs 304 may be detected at runtime using application monitoring. In one approach, VM images 306 are associated with BoEs 304. New BoEs may be defined by a user when new software is installed into VMs. A placement method (see e.g., FIGS. 9 and 10) ensures that BoEs 304 are not exceeded (e.g., in enforcement mode). In one embodiment, operating modes may include an enforcement mode where—license limits are never exceeded. Other modes may include warning modes, e.g., ask a user if enforcement leads to poor performance or ask a user if enforcement prevents a topology deployment. Other modes can be adapted based upon the particular system.

The modeling concept 302 advantageously permits a generic extension to be added to placement constraints 314. This makes them easily identifiable. Entitlements permit the representation of constraints 314 that are more complex than a constraint on a single machine or application—entitlement restrictions can cross multiple applications, etc. The entitlements may be shared between artifacts. Advantageously, entitlements are added to the representation of the placement problem in a way that supports additional implementations in the future for different types of licenses and even for different types of complex constraints.

An entitlement provider or BoE 304 may include representations of how many of a given entitlement are available, how to compute how many of that entitlement are currently in use; and how to compute what the impact of a suggested change would be on the entitlement usage. The BOEs 304 may include formulas, look-up tables with requirements, program logic, etc. An entitlement client 312 is attached to existing artifacts (e.g., applications/VMs 306, containers 308, etc.) in the placement problem. A single entitlement client 312 attaches the artifact to a single entitlement provider 304 and carries per-artifact usage information to help the provider compute the overall usage.

Referring to FIG. 9, an exemplary placement method which includes entitlements is shown in accordance with one embodiment. For an initial placement, a change is proposed and computed in block 402. In block 404, a determination is made as to whether the placement solution improved. If there is no improvement, then the last best solution is the output in block 406. If an improvement is achieved, the placement solution is modified to avoid entitlement violations in block 408. If there is sufficient time in block 410, the method iterates again returning to block 402. If there is not sufficient time, then the method goes to block 406.

Referring to FIG. 10, an exemplary placement method which includes entitlements is shown in accordance with another embodiment. For an initial placement, changes from a candidate placement are computed considering entitlements internally in block 412. In block 414, a determination is made as to whether the placement solution improved sufficiently. If there is no improvement, then the last best solution is the output in block 416. If an improvement is achieved, and if there is sufficient time in block 420, the method iterates again returning to block 412. If there is not sufficient time, then the method goes to block 416.

Having described preferred embodiments of a system and method for management of license entitlements in a virtualized environment (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A management system for a virtualized environment, comprising:
at least one computer entity having a usage limitation based on an entitlement;
a resource manager using a processor and programmed on and executed from a memory storage device, the resource manager being configured to manage resources in a virtualized environment; and
an entitlement-usage module coupled to the resource manager and configured to track entitlement-related constraints in accordance with changes in the virtualized environment to permit the resource manager to make allocation decisions which include the entitlement-related constraints to ensure that the usage limitation is met for the at least one computer entity.

2. The system as recited in claim 1, wherein the at least one computer entity includes at least one of a virtual machine, an application and a container.

3. The system as recited in claim 1, wherein the resource manager makes placement decisions based on at least one other consideration.

4. The system as recited in claim 3, wherein the at least one other consideration includes at least one of performance, cost and security.

5. The system as recited in claim 1, wherein the resource manager includes a program configured to make placement decisions based upon a candidate placement change.

6. The system as recited in claim 1, wherein the resource manager includes a program configured to make placement decisions by modifying a placement solution to avoid entitlement violations.

7. The system as recited in claim 1, further comprising a bucket of entitlements associated with the at least one computer entity and configured to identify the entitlement-based constraints for the at least one computer entity.

8. The system as recited in claim 1, further comprising an enforcement mode during which entitlements are not permitted to be exceeded, and a warning mode where a separate permission is needed to exceed the entitlements.

9. A method for managing resources in a virtualized environment, comprising:
representing constraints for a set of entitlements in a computer storage media;
determining, for a computing entity to be placed, how many and what type of entitlements are permitted; and
computing entitlement usage of a current candidate placement solution using a processor as a placement program progresses, such that a resulting placement solution does not exceed the entitlements that are available.

10. The method as recited in claim 9, wherein representing constraints for a set of entitlements includes providing an extension designated for files including constraint information.

11. The method as recited in claim 9, further comprising limiting resource usage in accordance with the constraints for the set of entitlements.

12. The method as recited in claim 9, wherein the computing entity includes a virtual machine.

13. The method as recited in claim 9, wherein the set of entitlements includes license limits and the method further comprises capturing the license limits in buckets of entitlements which are associated with computer entities and model license constraints.

14. The method as recited in claim 9, further comprising computing at least one of a performance metric, a cost metric and a security metric for a current candidate placement solution such that the resulting placement solution does not exceed the entitlements that are available and threshold for a respective metric.

15. The method as recited in claim 9, further comprising modifying a placement solution to avoid entitlement violations.

16. The method as recited in claim 9, further comprising providing an enforcement mode during which entitlements are not permitted to be exceeded, and a warning mode where a separate permission is needed to exceed the entitlements.

17. The method as recited in claim 9, further comprising providing a caller with a current level of usage of each entitlement type.

18. A computer readable storage medium comprising a computer readable program for managing resources in a virtualized environment, wherein the computer readable program when executed on a computer causes the computer to:
representing constraints for a set of entitlements;
determining, for a computing entity to be placed, how many and what type of entitlements are permitted; and
computing entitlement usage of a current candidate placement solution as a placement program progresses, such that a resulting placement solution does not exceed the entitlements that are available.

19. The computer readable storage medium as recited in claim 18, wherein representing constraints for a set of entitlements includes providing an extension designated for files including constraint information.

20. The computer readable storage medium as recited in claim 18, further comprising limiting resource usage in accordance with the constraints for the set of entitlements.

21. The computer readable storage medium as recited in claim 18, wherein the set of entitlements includes license limits and the method further comprises capturing the license limits in buckets of entitlements which are associated with computer entities and model license constraints.

22. The computer readable storage medium as recited in claim 18, further comprising computing at least one of a performance metric, a cost metric and a security metric a current candidate placement solution such that the resulting placement solution does not exceed the entitlements that are available and threshold for a respective metric.

23. The computer readable storage medium as recited in claim 18, further comprising modifying a placement solution to avoid entitlement violations.

24. The computer readable storage medium as recited in claim 18, further comprising providing an enforcement mode during which entitlements are not permitted to be exceeded, and a warning mode where a separate permission is need to exceed the entitlements.

25. The computer readable storage medium as recited in claim 18, further comprising providing a caller with a current level of usage of each entitlement type.
